(19) United States
(12) Patent Application Publication
(10) Pub. No.: US 2018/0346825 A1
(43) Pub. Date: Dec. 6, 2018

(54) COMPOSITION OF SEQUESTRANT FOR APPLICATION TO THE ELIMINATION AND/OR REDUCTION OF HYDROGEN SULFIDE AND/OR MERCAPTANS IN FLUID

(71) Applicant: OXITENO S.A. INDÚSTRIA E COMÉRCIO, Sao Paulo SP (BR)

(72) Inventors: Camilo Enrique La Rotta HERNÁNDEZ, Santo André (BR); Luis Henrique DE FREITAS, São Paulo (BR); Guilherme Bazzeggio DA FONSECA, Santo André (BR)

(21) Appl. No.: 15/775,697

(22) PCT Filed: Nov. 10, 2016
(86) PCT No.: PCT/BR2016/050292

§ 371 Date: May 11, 2018

(30) Foreign Application Priority Data
Nov. 13, 2015 (BR) BR 102015028532-9

(51) Int. Cl. C10G 29/22; B01D 53/52; B01D 53/79; C02F 1/68; C10L 3/10; C10G 29/20; C10G 73/42

(52) U.S. Cl. CPC C10G 29/22; B01D 53/52; B01D 53/79; C02F 2101/101; C10L 3/103; C10G 29/20; C10G 73/42; C02F 1/683

(57) ABSTRACT

The invention discloses a sequestrant composition for application to the elimination and/or reduction of hydrogen sulfide and/or mercaptans in fluid, particularly the reduction or elimination of hydrogen sulfide from gases and liquids, including gaseous and liquid hydrocarbons, and sewage gases, especially from natural gas and liquid hydrocarbon streams. The composition uses a main scavenger agent and sequestration rate accelerator additive that also acts as a precipitation prevention agent. The use of the composition is described as being the main scavenger agent for a 1,3-dioxolane alkyl, alkenyl and/or hydroxyl derivative and ketone-based accelerator additives that include α-diketones and cyclic ketones, saturated and/or α-unsaturated.

### FIELD OF THE INVENTION

This invention addresses the formulation of a composition applied for the removal, reduction or elimination of hydrogen sulfide and/or mercaptans present in gas and liquid streams, including gaseous and liquid hydrocarbons. The formulation composition described in this Invention makes concomitant use of at least one main scavenger and precipitate formation prevention agent. Formulation composition containing at least one main scavenger agent and one enhancer agent. The formulation composition describes the use of at least one main scavenger agent corresponding to a 1,3-dioxolane alkyl, alkenyl and/or hydroxyl derivative. The formulation composition describes the use of accelerator additives corresponding to linear or branched ketones, cyclic α-diketones or ketones, saturated and/or α-unsaturated.

In another aspect, this Invention discloses that the activity of the main scavenger agent is accelerated by the presence of a certain amount of an additive or an additive mixture called an enhancer agent that increases the sequestration rate of the main sequestration agent by generating hydroxythiols, thiones, gem-dithiols and/or vinyl thiols and/or thiol-epi.

### BACKGROUND OF THE INVENTION

Hydrogen sulfide (H2S) is a dangerous and highly toxic gas that may lead to death by exposure at concentrations in the air above 10 ppm. In the oil and gas industries, preventive safety measures and treatment, as well as regulations on exposure limits and permissible concentrations of hydrogen sulfide have has been widely deployed in order to preserve human safety and the useful life and integrity of assets and equipment. Furthermore, hydrogen sulfide may cause instability in the permeability of the formation through precipitate generation, increased formation of sulfide salt solids and increased pipeline corrosion. Thus, the removal of hydrogen sulfide from the formation or the spent fluid from the exploration and production of oil and natural gas has become a necessity.

Sequestrants consist of chemical products that should react favorably with H2S and lead to the generation of non-reversible products that are soluble in the oily or aqueous phases and are compatible with the environment.

Sequestrants may be an alternative way of preventing corrosion and safety hazards due to the presence of hydrogen sulfide, in conventional gas/liquid “sweetening” processes, such as in a gas scrubbing unit using amine solutions or membranes. Sequestrants provide effective treatment for a wide range of applications including: removal of hydrogen sulfide gas streams; removal of hydrogen sulfide from hydrocarbon acids, liquid condensate streams and natural gas; reduction of hydrogen sulfide vapor spaces in storage tanks.

Sequestrant selection depends on the nature of the hydrogen sulfide problem to be addressed and the oil or natural gas streams to be treated. There are thus three main types of H2S scavengers: a) water soluble—wherein the sequestrant is chosen for applications at temperatures below 200° F. (93° C.), preferably, for use in flare gas, liquefied petroleum gas, crude oil and waste oils; b) oil soluble—used in high temperature applications, or when hydrocarbon water tolerance is a problem, with these products being typically amine based; and c) sequestrants based on carboxyl metals that are tailored to specific needs at very high temperatures and high hydrogen sulfide concentrations, typically used to treat asphalts.

Hydrogen sulfide sequestrants (scavengers) have been used extensively in different operations in the oil and gas industry including field operations during drilling, secondary oil recovery and acid stimulation treatments; during the transport of oil, gas and derivatives; and in the refining activities, including thermochemical sulfate reduction and thermal cracking.

Regenerable sequestrants are based on concentrated aqueous alkanolamine solutions and are by far the most common chemical method of removing hydrogen sulfide from produced natural gas. Typically, non-regenerable hydrogen sulfide sequestrants are designed to react effectively under in-situ conditions; triazines are designed for conditions above pH 7; while aldehyde-based sequestrants are used under low pH conditions.

U.S. Pat. No. 6,063,346 discloses treatments for the removal of sulfhydryl compounds and mercaptans from hydrocarbons and other substrates using nitrogenated derivatives such as maleimides, amines, carboxamides, alkyl carboxylic azo compounds and cumene-peroxide compounds. Additionally, U.S. Pat. No. 5,128,049 describes the use of other nitrogenates such as morpholine analogs and other amine derivatives.

Sulfhydryl compounds, including hydrogen sulfide and mercaptans, can also be removed from fluids or gas streams or substrate through the reaction of the sulfhydryl sequestrants based triazines as described for gas and/or aqueous streams in U.S. Pat. Nos. 6,063,346, 5,128,049, 2011.0220.551 A1, or for oily and organic streams in U.S. Pat. No. 8,512,449 BI. This type of molecule is typically efficient when used in gas scrubbers (liquid/gas) through direct atomization. However, its effect is markedly decreased when used in liquid hydrocarbon streams with low water concentration, and may also be decreased when atomized into very dry gas streams.

However, there are problems with the use of triazines, due mainly to the ethanolamine generation deriving from the reaction, which increases the pH and, when coining into contact with the dissolved carbon dioxide and calcium ions, causes them to precipitate into calcium carbonate which may, depending on the concentration, lead to fouling through encrustations or scaling, and consequently flow loss.

In addition to nitrogenated derivatives for sequestering hydrogen sulfide, products based on carbonyl compounds have already been reported. An example of this technology corresponds to those addressed by U.S. Pat. Nos. 4,680,127, 5,085,842 A, 8,354,087, 8,771,603 2011.0236.281 and 2013.0101.473, describing methods for reducing or scrubbing hydrogen sulfide from wet gaseous mediums based on aldehydes such as glyoxal, formaldehyde, glutaraldehyde, and acrolein.

However, problems related to the toxicity and carcinogenicity of these compounds have been linked to their handling and exposure by workers. Additionally, other problems have been reported such as generation of water-insoluble derivatives such as 1,2,3-trithianes and side chain variable thioxolanes, depending on the starting aldehyde. Another drawback to the use of aldehydes is their low reaction rate in comparison with triazine, particularly at low temperatures. However, aldehydes are still used, especially in oil recovery activities through injecting seawater, due to its biocide capability that is useful for treating problems caused by sulfate reducing bacteria (SRB).

U.S. Pat. No. 7,078,005 B2 discloses a process for reducing the hydrogen sulfide level in a liquid or gas through treatment with a hydrogen sulfide scavenger product comprising (i) ethylene glycol hemiformal or [1,2-ethanediyl bis (oxy)]-bis-methanol or 1,6-dihydroxy 2,5-dioxahexane derived from the (1:2) reaction between ethylene glycol and formaldehyde. The patent also describes the use of a heterocyclic hemiacetal product or (ii) 1,3-dioxolane formed from formaldehyde and ethylene glycol (1:1). This patent confirms the advantage of using the main product (i) as the advantageous elimination or minimization of problems due to the formation of calcium carbonate scale encountered with the use of triazines. Additionally, pH value stabilization is mentioned after use of the product (i) as a scavenger.

Moreover, also mentioned among the carbonyl derivatives listed in U.S. Pat. No. 7,078,005 B2, which include ethylene glycol condensation products, are mentioned among condensates between urea and formaldehyde, forming dimethylol urea or N, N-bis (hydroxymethyl) urea (iii), as well as others including butylformyl or butoxymethanol (iv). Derivatives (iii and iv) have hydrogen sulfide scavenging activity. However, U.S. Pat. No. 7,078,005 B2 contains a contradictory mention of heterocyclic hemiketal derivatives (ii) stating that there was no reaction between them and sulfhydryl ions.

The main derivative of the reaction between hydrogen sulfide with either aldehydes or ketals is known as 1,3,5-trithiane which corresponds to the simplest representative of the parent heterocyclic family, called trithianes. Most of the different species in this family are obtained through processes adding sulfur to ketones and aldehydes, whose respective thioketone and thioaldehyde derivatives undergo trimerization (thermally reversible).

The main products of triazines reacting with hydrogen sulfide also correspond mainly to 6-member sulfur cyclic derivatives (1,3,5-trithianes) and to a lesser extent 7-member sulfur cyclic derivatives (1 4,5-trithiepanes).

As disclosed by U.S. Pat. No. 3,544,592 on the trithiane purification process, it is surprisingly demonstrated that water is an excellent medium for trithiane recrystallization, as it is practically insoluble in both cold and hot water under normal pressure conditions. However, under supercritical pressure conditions, the solubilization of trithiepane and trithiane derivatives can be achieved. Nevertheless, under some conditions found at hydrogen sulfide scavenger application points, the precipitation and crystallization for these products commonly occur, due to the presence of water.

U.S. Pat. No. 5,622,919A, which discloses the composition and method for the acidification of an oil formation in the presence of ferric ions and free sulfur and/or sulfide, mentions the use of certain sulfide-reactive compounds as precipitation prevention agents, including: saturated α-diketones, α-unsaturated cyclic ketones, saturated cyclic ketones or α-unsaturated cyclic ketones. In addition to being very effective for controlling ferrous sulfide precipitation, these ketones also present an action reducing the quantity of sulfides and derivatives.

As set forth above, this Invention discloses a process for eliminating, reducing or minimizing the level of hydrogen sulfide in a liquid or gas stream of hydrocarbons derived from oil or natural gas, or from the aqueous or oily streams, or from mixtures resulting from oil or natural gas processing, based on hydrogen sulfide sequestration through treatment with a scavenger agent comprised of one or more derivatives of 1,3-dioxolane alkyl, alkenyl and/or hydroxyl with a ketone-based additive.

The 1,3-dioxolane derivatives described in this Invention, to be deployed as the main sequestrant include products with aliphatic portions (saturated or unsaturated) or cycloaliphatic portions at positions 2, 4 and/or 5, and/or may include one or more hydroxyls or alkyl hydroxyls at positions 2, 4 and/or 5 and/or saturated or unsaturated hydroxylated chains at positions 2, 4 and/or 5 on the dioxolane ring. The type of substitute for the 1,3-dioxolane derivatives disclosed in this Invention may cause a greater solubility in the oil phase, depending on side chain size, or greater solubility in the aqueous phase, depending on the presence of hydroxyl clusters.

The various carbonyl derivatives of aldehydes to be used as additives to increase the sequestration rate of the 1,3-dioxolane derivatives described in this Invention exhibit activity as agents preventing sulfur derivative precipitation after the reaction between the scavengers and the hydrogen sulfide, in addition to speeding up the sequestration of the 1,3-dioxolane derivatives used as the main sequestrants.

In addition to providing fast sequestration, the scavenger compositions described in this Invention avoid or minimize the calcium carbonate precipitation problems mentioned above, as they do not increase the pH through generating of alkanolamines, as occurs with triazine-based nitrogenated compounds.

### DETAILED DESCRIPTION OF THE GROUNDS FOR THE INVENTION

Despite the grounds for some of the above-mentioned inventions stating that the reaction between cyclic hemiacetal derivatives such as 1,3-dioxolane and hydrogen sulfide does not occur in the same way as it does with linear hemiacetals, or even does not happen at all, and although the available literature on this type of reaction is insufficient, there are some reports describing the reaction of acetals and hydrogen sulfide as somewhat similar to hydrolysis. However, from the nature of the products formed, it is possible to define that bonds are ruptured during thiolysis by 1,3-dioxolane derivatives at the initial step in the hydrogen sulfide sequestration process.

For 1,3-dioxolane derivatives (a), the oxygen-alkylidene rupture should thus lead to the formation of (1) both mercaptan and the semitial structure (b) or its transformation product, trithioacetaldehyde, also called 2,4,6-trimethyl 1,3,5-trithiane (c). At the same time, oxygen alkyl rupture (2) should lead to acetaldehyde (d) and monothioglycol (e).

It has been found that 1,3-dioxolane derivative thiolysis in the presence of an acid catalyst is conducted mainly in the direction of (1), forming trithioacetaldehyde (c). The acetaldehyde that may be formed here probably results from the decomposition of the acetal-acid catalyst complex intermediary. The sequestration reaction described in this Invention is conducted through the formation of a highly active intermediary through carbonium ions reacting with hydrogen sulfide and sulfhydryl ions during a nucleophilic attack.

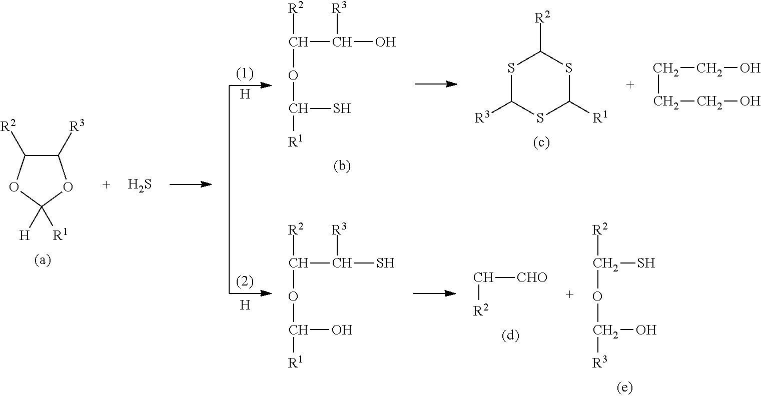

The action of the sequestration potentiation additive is based on the reaction where, if hydrogen sulfide is placed in contact with a ketone (f) in the presence of a basic medium, different gem-dithiols yields are formed (g) or thioketones (h), in special cases. Particularly, gem-dithiols will be formed more easily from aldehydes than from ketones, which present steric hindrance. Gem-dithiols are cold-formed very easily from ketones in basic mediums.

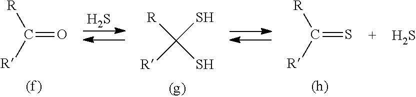

Where:

R=—CH₃ to C₆H₁₃

R′=—CH₃ to C₆H₁₃

R=—CH₃; R′=cyclohexyl

R=Preferably to C₆H₁₃ (including Vinyl)

R′=Preferably to C₆H₁₃ (including Vinyl)

The reaction conditions for the synthesis of gem-dithiols or thioketones that are dependent on the ketone that is converted and may consequently be generalized only within a temperature range of 0° C. to 20° C., prove to be favorable; under higher temperatures, such as those encountered during oil and gas exploration and production activities (30° C. to 150° C.), heterocyclic sulfur compounds occur as secondary products.

In terms of preventing precipitation through the solubilization of hydrogen sulfide sequestration by-products using 1,3-dioxolanes and hemicetal derivatives (especially ethylene glycol hemiformal derivatives), the addition of aldehydes and especially ketones in order to produce hydroxy thiols or the corresponding conjugate acids proves efficient. As is well-known, the reaction between primary carbonyls (e.g. formaldehydes), as well as simple ketones such as acetone, ethyl methyl ketone and hydrogen sulfide leads to the formation of thioformaldehyde or its trimer s-trithiane.

Especially in the case of hemiformals such as ethylene glycol hemiformal, which may eventually eliminate hydronium ions to produce thiones (i) or thials, depending on the starting carbonyl, or trimerize directly to form trithiane (ii), hydroxythiols (v) may undergo dehydration to form enethiols (viii), followed by condensation to form unsaturated sulfides (vii) or undergo simple condensation giving rise to α,α-dihydroxysulfides (ix). Ketones (iv) react with hydrogen sulfide to form hydroxythiols (v) which may in turn react again with hydrogen sulfide to produce gem-thiols (VI). Products (v) and (vi) may both be subject to spontaneous condensation generating polysulfides (iii) which continue in the organic chain without precipitating and may be eliminated during oil or gas desulfurization post-treatment processes. Under dehydration conditions, the balance will be shifted to the formation of sulfide polymers (iii) in the presence of excess hydrogen sulfide or oligomeric products (vii and ix) in the presence of carbonyls other than simple ketones and aldehydes.

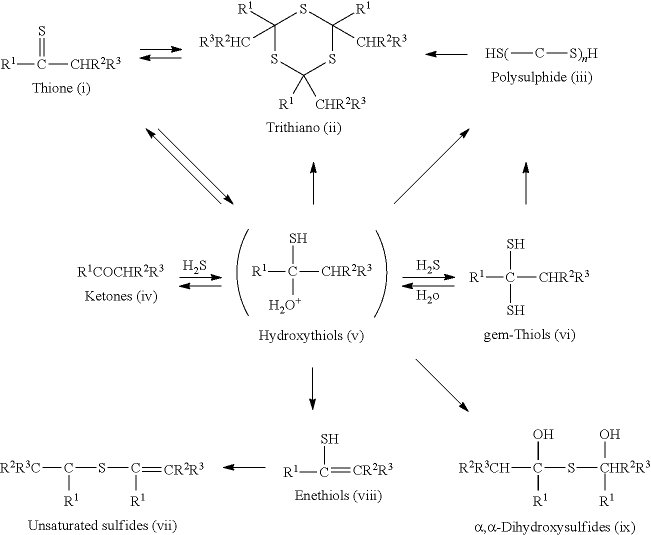

Preferably, the accelerator additive is based on a carbonyl compound, preferably a ketone containing 1 to 10 carbon atoms. Specifically, but not limited to ketones: acetone, methyl ethyl ketone, methyl isopropyl ketone, cyclohexanene, alkyl cyclohexanene, hexanenes and heptanones or ketones with to 8 carbon atoms, preferably using ketone with chains of 5 to 8 carbon atoms, saturated or unsaturated, cyclohexanenes and/or saturated or unsaturated alkyl cyclohexanenes.

### SUMMARY OF THE INVENTION

This invention addresses the formulation composition of a for scavenger agent for hydrogen sulfide and/or mercaptans in gas and/or liquid streams, including gaseous and/or liquid hydrocarbons. The composition resulting from this Invention describes hydrogen sulfide sequestration by the use of the so-called main sequestrant.

This invention discloses increased kinetics in the reaction of the so-called main sequestrant caused by the presence of a enhancer agent.

The formulation resulting from this Invention discloses the sequestration of hydrogen sulfide and/or mercaptans by the main sequestrant, with faster sequestration and reductions and/or elimination of precipitate formation through concomitant use of the enhancer agent.

The formulation resulting from this Invention is comprised of the products to be called the “main sequestrant”, corresponding to one or more alkyl, alkenyl, cycloalkyl or cycloalkenyl derivatives or hydroxyl or alkyl hydroxyl, or 1,3-dioxolane polyhydroxyl, or alkenyl hydroxyl derivatives.

The products called enhancer agents correspond to one or more ketone derivatives of alkyl, cycloalkyl, or alkenyl and may contain one or more hydroxyl clusters and one or more unsaturations.

The formulation of product of the Invention comprises the use of at least one or more products as described in [00035], individually and/or concomitantly with at least one of the products to be called enhancer agents as described in [00036].

### DISCLOSURE OF THE INVENTION

This invention relates to the composition of a high-efficiency hydrogen sulfide and/or mercaptan scavenger agent. The scavenger agent disclosed in this Invention corresponds to a product or mixture of products to be called the “main sequestrant” corresponding to one or more of alkyl, alkenyl and/or hydroxyl 1,3-dioxolane derivatives, to be used alone or in mixtures with products called the “enhancer agent”, corresponding to carbonyl derivatives of alkyl, cycloalkyl, alkenyl and/or cycloalkenyl, and may contain one or more hydroxyl clusters.

This invention provides an effective method for the rapid removal, partial reduction and/or complete elimination of hydrogen sulfide from fluids and liquid and/or gaseous streams when drilling oil and/or natural gas extraction wells; and the storage, transportation and/or treatment of acidic streams resulting from oil production and/or natural gas processes.

The product addressed by this Invention may be deployed for the elimination and/or reduction of hydrogen sulfide from hydrocarbons such as crude oil, bitumen and/or asphalt, as well as brine and/or other oil-water mixtures and/or other liquid wastes from oil and/or gas production wells and non-oil treatment streams (e.g. liquid wastes from mining, industrial drilling and other construction operations), as well as for the stowage or storage of production water, oil, gas, tars and/or any other petroleum hydrocarbons (e.g. offshore storage facilities).

The product described in this Invention is particularly suitable for the removal of hydrogen sulfide and its derivatives, including mercaptans and thiols from gas streams, and vapor space in refined oil and natural gas storage tanks, in addition to flare gases and hydrodesulfurization units, but is not limited to such applications.

The product described in this Invention is particularly suitable for the elimination of hydrogen sulfide when drilling groundwater, liquid and/or gaseous hydrocarbon wells; the production of liquid and/or gaseous hydrocarbons during liquid and/or gaseous hydrocarbons primary, secondary and enhanced recovery activities, including crude, natural gas, shale oil and shale gas, but is not limited to only such applications.

### Main Sequestrant

This invention addresses the use of one or mixture of two or more 1,3-dioxolane derivatives called the main sequestrant. The main sequestrant used in this Invention includes at least one of the 1,3-dioxolane derivatives represented by the following structural formula:

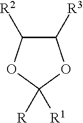

Where:

R and/or R′=—H and/or —CH₃ to —C₆H₁₃

R=R′=—CH₃ to —C₆H₁₃ (alkyl or alkenyl, including vinyl)

R² and/or R³=—H

R²=—OH

R³=—OH

R²=R³=—CH₃ to —C₆H₁₃ (alkyl or alkenyl, including vinyl)

R² and/or R³=—CH₂—OH

R² and/or R³=—CH, —OH (n=1 and m=2n+1H) (alkyl or alkenyl, including vinyl)

R and/or R′ and/or R² and/or R³=Aryl or alkylaryl

In a preferred embodiment, this Invention uses the derivatives alone or in a mixture of two or more of the following 1,3-dioxolane derivatives: 2-methyl 1,3-dioxolane and/or 2,2-dimethyl-1,3-dioxolane and/or 2-ethyl 2-methyl 1,3-dioxolane-4-ol and/or 2,2-methyl 1,3-dioxolane-4-ol and/or 2-ethyl-2-methyl 1,3-dioxolane-4-ol and/or 2-ethyl 2-methyl 1,3-dioxolane and/or 2-methyl 1,3-dioxolane and/or 4-methyl 1,3-dioxolane and/or 2-vinyl 1,3-dioxolane and/or 2-phenyl 1,3-dioxolane

In a preferred embodiment, this Invention recommends the use of the following 1,3-dioxolane derivatives: 2-ethyl 2-methyl 1,3-dioxolane-4-ol and/or 2-ethyl 2-methyl 1,3-dioxolane and/or 2,2-dimethyl 1,3-dioxolane.

The composition of the “main sequestrant” comprises the use of the 1,3-dioxolane derivatives mentioned in item [00043] either independently or in mixtures of two or more derivatives.

Preferably, for binary mixtures of 1,3-dioxolane derivatives (e.g. a1, a2 and a3) as disclosed in item [00045], the mixtures are comprised of possible combinations of a1a2, a2a3, a1a3 and so on, where the proportions of the derivatives may vary from 0% to 99.9%.

Preferably, for ternary mixtures of 1,3-dioxolane derivatives (e.g. a1, a2 and a3) as disclosed in item [00045], the mixtures are comprised of the possible combinations of a1, a2 and a3, where diversity of the mixture will be established by the ratio between each of the derivatives.

Preferably, 0.01% to 99.99% for a1 concentrations relative to a2 and/or a3.

Preferably, mixtures of more than three of the 1,3-dioxolane derivatives disclosed in item [00045], comprised of the possible combinations and proportions among the selected derivatives.

### Additive

This invention describes the use of one or more derivatives of the so-called “main sequestrants” concomitantly with synergistic agents called the “accelerator additives,” which act together to enhance the hydrogen sulfide removal kinetics and also prevent the formation of precipitation caused by the low solubility of the products resulting from the reaction between hydrogen sulfide and the so-called “main sequestrant”.

The above-mentioned enhanced kinetics of the “main sequestrant” is taken to be that observed when compared to the removal rate in the presence of the “additive”.

The above-mentioned improvement to the “main sequestrant” kinetics in the presence of the “additive” is taken to be that observed when compared to other triazine-based hydrogen sulfide sequestrants or in non-cyclic hemiformals or carboxyl metal complexes.

Preferably, the so-called “accelerator additives” correspond to ketone-type carbonyl compounds.

Particularly, the so-called “accelerator additive” corresponds to ketones with 3 to 8 carbon atoms, and may be alkyl and/or alkenyl ketones (with one or more unsaturations), linear ketones and/or branched ketones, cyclic ketones, cyclic alkyl and/or alkenyl ketones, hydroxy ketones (linear, branched and/or cyclic), substituted aryl alkyl ketones and alpha-diketones.

The composition of the “accelerator additive” comprises use of the carbonyl compounds disclosed in item [00052] either independently or in mixtures of two or more compounds.

Preferably, the ketones indicated for use in the so-called “accelerator additive” include alkyl ketones (e.g. acetone, diethyl ketone, methyl ethyl ketone, methyl propyl ketone, methyl isopropylketone, butyl ethyl ketone, methyl amyl ketone, methyl hexyl ketone, methyl heptyl ketone, methyl isobutyl ketone, and/or diketones (e.g. 2,3-butanedione) and/or cyclic ketones (e.g. cyclohexanene 2-cyclohexyl cyclohexanene), and/or hydroxy ketones (e.g. 4-hydroxy 4-methyl diacetone), and/or alkyl ketones, substituted aryl (e.g. methyl naphthyl ketone) and/or alkenyl ketones (e.g. 3-methyl 3-heptene-5-one), but is not restricted solely to those listed above.

Specifically, the ketones suggested for use in the so-called “accelerator additive” correspond to 2,3-butanedione (b1) and/or cyclohexyl cyclohexanene (b2) and/or 3-methyl 3-heptene-5-one (b3).

Preferably, for binary mixtures of the carbonyl compounds disclosed in items [00053 and/or 00054], mixtures comprised of possible combinations of additives (b1, b2 and b3): b1b2, and b2b3 b1b3.

Preferably, for the ternary mixtures of carbonyl compounds disclosed in items [00053 and/or 00054], mixtures comprised of possible combinations of additives (b1, b2 and b3), where the diversity of each mixture will be established by the relation among each of the selected derivatives.

Preferably, for the above-mentioned mixture of three components disclosed in items [00053 and/or 00054], mixtures comprised of possible combinations of selected additives.

### Formulation

The formulation composition discloses the use of an agent called the “primary sequestrant” and an agent called the “accelerator additive.”

In preferred embodiment, the formulation composition discloses the use of 1,3-dioxolane derivatives as “main sequestrants” and ketone-type compounds as the “accelerator additives”.

Preferably, the main sequestrant may be added alone or in mixtures of the so-called “main sequestrants” as disclosed in item [00037], concomitantly with one or more so-called “accelerator additives” as disclosed in items [00053 and/or 00054].

In a preferred embodiment, the compositions resulting from this Invention use the following, either alone in mixtures called the “main sequestrants”: 2-ethyl 2-methyl 1,3-dioxolane-4-ol (a1) and/or 2-ethyl 2-methyl 1,3-dioxolane (a2) and/or 2,2-dioxolane (a3).

Particularly, it is suggested that the product formulations of this Invention preferably use the following, either alone or in a mixture of the so-called “accelerator additives”: 2,3-butananedione (b1) and/or cyclohexyl cyclohexanene (b2) and/or 3-methyl 3-heptene-5-one (b3).

In a preferred embodiment, the formulation addressed by this Invention indicates the use of a “main sequestrant” a1, a2 or a3, together with a “accelerator additive” b1, b2, b3, and possible combinations thereof.

Particularly, the “main sequestrant” may be at concentrations of 99.99% in relation to the “accelerator additive”.

In a preferred embodiment, “main sequestrant” concentrations of more than 50% of the total formulation are suggested.

Particularly, use of the following proportions is suggested for the “main sequestrant” and the “additive”: 50:50, 60:40, 70:30, 80:20, 90:10.

In a preferred embodiment, use of the following proportions is suggested for the “main sequestrant” and the “accelerator additive”: respectively 75:25.

Countless variations are permitted within the scope of this application, thus underscoring the fact that this Invention is not limited to the particular configurations/embodiments described above.

In a particular embodiment, the formulation of the hydrogen sulfide and/or mercaptan sequestrant resulting from this Invention may use one or more 1,3-dioxolane derivatives separately from the accelerator additive.

In a recommended embodiment, the main sequestrant consisting of a 1,3-dioxolane derivative should be deployed concomitantly with the accelerator additive.

Consequently, the invention provides a sequestrant composition for application to the elimination and/or reduction of hydrogen sulfide and/or mercaptans in fluid, with fluid taken as meaning any liquid, liquid-gas or gas streams containing hydrogen sulfide, sulfhydryl and/or mercaptans in solution, characterized in that it comprises a mixture that includes:
a) 0% to 99.99% by weight of at least one main sequestrant of hydrogen sulfide and/or mercaptans that will eliminate or reduce hydrogen sulfide and/or mercaptans in solution through the formation of thioacetaldehyde derivatives, monothioglycol and/or trithiepanes, to be called Component A; and
b) 99.99 to 0% by weight of at least one enhancer agent that will increase the main sequestrant removal speed and mitigate, avoid or prevent the formation of solids and precipitates through the subsequent generation of polysulfides via gem-thiols and/or hydroxythiols, unsaturated sulfates via enethiols and/or via dihydroxysulfides through hydroxythiols, to be called Component B,
where:
at least one Component A is used, consisting of a mixture of one or more 1,3-dioxolane derivatives represented by the structural formula below:

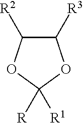

whereby:
R and/or R′ corresponds to —H and/or —CH₃ to —C₆H₁₃, and/or
R or R′ corresponds to —CH₃ or —C₆H₁₃ chain, which may be alkyl or alkenyl (including vinyl); and/or
R² and/or R³ corresponds to —H; and/or
R² and/or R³ corresponds to —OH; and/or
R² and/or R³ corresponds to —CH₃ to C₆H₁₃ (alkyl or alkenyl, including vinyl); and/or
R² and/or R³ corresponds to —CH₂—OH and/or —CₙHₘ—OH (n=1 and 2n+1=H) (alkyl or alkenyl, including vinyl); and/or
R and/or R¹ and/or R² and/or R³=Aryl or alkylaryl;
using at least one Component B, corresponding to ketone-type carbonyl compounds that include linear, branched, aromatic and/or cyclic ketones, substituted aryl alkyl ketones and alpha-diketones represented by the structural formula below:

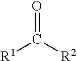

in which:
R¹ and/or R² correspond to the CₙH₂ₙ₊₁, alkyl chains, preferably containing from C₁ to C₈; and/or
R¹ and/or R² correspond to the CₙH₂ₙ alkenyl chains, preferably containing C₁ to C₈; and/or
R¹ and/or R² correspond to aryl, cyclic alkenyl, hydroxy alkyl and/or hydroxy alkenyl.

In a preferred embodiment of the composition according to the invention:
Component A is preferably selected from one or more of the following 1,3-dioxolane derivatives:
a1) 2-ethyl 2-methyl 1,3-dioxolane-4-ol; and/or
a2) 2-ethyl 2-methyl 1,3-dioxolane; and/or
a3); 2,2-dimethyl 1,3-dioxolane; and/or
Component B is preferably selected from one or more of the following ketone derivatives:
b1) 2,3-dutanedione; and/or
b2) cyclohexyl cyclohexanene; and/or
b3) 3-methyl 3-heptene-5-one.

In another preferred embodiment of the composition according to the above-mentioned invention, the ratio between Component A and Component B is 50:50, preferably but not limited to:
Mixture 1: A1 (2-ethyl 2-methyl 1,3-dioxolane) and 50% B3 (3-methyl 3-heptene-5-one) 50%; and/or
Mixture 2: A1 (2-ethyl 2-methyl 1,3-dioxolane) and 50% B2 (cyclohexyl cyclohexanene) 50%; and/or
Mixture 3: A1 (2-ethyl 2-methyl 1,3-dioxolane) and 50% b1 (2,3 butananedione) 50%; and/or
Mixture 4: A2 (2-ethyl 2-methyl 1,3-dioxolane-4-ol) and 50% B3 (3-methyl 3-heptene-5-one) 50%; and/or
Mixture 5: A2 (2-ethyl 2-methyl 1,3-dioxolane-4-ol) 50% and b2 (cyclohexyl cyclohexanene) 50%; and/or
Mixture 6: A2 (2-ethyl 2-methyl 1,3-dioxolane-4-ol) and 50% b1 (2,3 butananedione) 50%; and/or
Mixture 7: A3 (2-ethyl 2-methyl 1,3-dioxolane-4-ol) and 50% B3 (3-methyl 3-heptene-5-one) 50%; and/or
Mixture 8: a3 (2-ethyl 2-methyl 1,3-dioxolane-4-ol) 50% and b2 (cyclohexyl cyclohexanene) 50%; and/or
Mixture 9: A3 (2-ethyl 2-methyl 1,3-dioxolane-4-ol) and 50% b1 (2,3 butananedione) 50%.

In another preferred embodiment of the composition according to the above-mentioned invention, the ratio between Component A and Component B is respectively 75:25, preferably but not limited to:
Mixture 1: A1 (2-ethyl 2-methyl 1,3-dioxolane) and 75% B3 (3-methyl 3-heptene-5-one) 25%; and/or
Mixture 2: A1 (2-ethyl 2-methyl 1,3-dioxolane) and 75% B2 (cyclohexyl cyclohexanene) 25%; and/or
Mixture 3: A1 (2-ethyl 2-methyl 1,3-dioxolane) and 75% b1 (2,3 butananedione) 25%; and/or
Mixture 4: A2 (2-ethyl 2-methyl 1,3-dioxolane-4-ol) and 75% B3 (3-methyl 3-heptene-5-one) 25%; and/or
Mixture 5: A2 (2-ethyl 2-methyl 1,3-dioxolane-4-ol) 75% and b2 (cyclohexyl cyclohexanene) 25%; and/or
Mixture 6: A2 (2-ethyl 2-methyl 1,3-dioxolane-4-ol) and 75% b 1 (2,3 butananedione) 25%; and/or
Mixture 7: A3 (2-ethyl 2-methyl 1,3-dioxolane-4-ol) and 75% B3 (3-methyl 3-heptene-5-one) 25%; and/or
Mixture 8: a3 (2-ethyl 2-methyl 1,3-dioxolane-4-ol) 75% and b2 (cyclohexyl cyclohexanene) 25%; and/or
Mixture 9: A3 (2-ethyl 2-methyl 1,3-dioxolane-4-ol) and 75% b1 (2,3 butananedione) 25%.

In another preferred embodiment of the composition according to the above-mentioned invention, the hydrogen sulfide and/or mercaptan sequestrant product is substantially free of water.

In another preferred embodiment of the composition according to the above-mentioned invention, the hydrogen sulfide and/or mercaptan sequestrant product has a pH in the range of 4 to 11.

In another preferred embodiment of the composition according to the above-mentioned invention, the sequestrant product is used to reduce or eliminate hydrogen sulfide and/or mercaptans from a gas containing water and/or liquid and/or gaseous hydrocarbons.

In another preferred embodiment of the composition according to the above-mentioned invention, the sequestrant product is used to reduce or eliminate hydrogen sulfide and/or mercaptans present in aqueous solutions and/or brines and/or water/oil dispersions and/or water/oil emulsions and/or oil/water emulsions.

In another preferred embodiment of the composition according to the above-mentioned invention, the sequestrant product is used to reduce or eliminate hydrogen sulfide and/or mercaptans from a refined fuel, including liquefied petroleum gas and/or gasoline and/or naphtha and/or kerosene and/or other hydrocarbons.

In another preferred embodiment of the composition according to the above-mentioned invention, the sequestrant product is used to reduce or eliminate hydrogen sulfide and/or mercaptans from other refined fractions, including paraffin waxes and/or asphaltenes and/or bitumen and/or petroleum coke.

In another preferred embodiment of the composition according to the above-mentioned invention, the sequestrant product is used to reduce, eliminate or remove hydrogen sulfide and/or mercaptans from sewage gas and/or wastewaters, including industrial and/or domestic liquid wastes.

In another preferred embodiment of the composition according to the above-mentioned invention, the sequestrant product is in solution.

In another preferred embodiment of the composition according to the above-mentioned invention, the sequestrant product is dissolved in a hydrocarbon.

In another preferred embodiment of the composition according to the above-mentioned invention, the sequestrant product is dissolved in an alcohol and/or glycol and/or mixtures thereof.

In another preferred embodiment of the composition according to the above-mentioned invention, the sequestrant product is dissolved in water.

In another preferred embodiment of the composition according to the above-mentioned invention, the sequestrant product is dissolved in combinations of the solvents described above.

In another preferred embodiment of the composition according to the above-mentioned invention, the sequestrant product is dispersed and/or emulsified in a hydrocarbon and/or water.

In another preferred embodiment of the composition according to the above-mentioned invention, the main sequestrant described as Component A in the formulation may also be used alone as a hydrogen sulfide and/or mercaptan sequestrant, without the addition of the accelerator additive called Component B.

### EXAMPLES

In all the examples, a hydrogen sulfide concentration of 100 ppm was generated in situ from Na₂S.9H₂O and an aqueous solution of 0.01 M NaOH pH 11. Then 100 ppm of the sequestrant or the additive or mixtures thereof were added (total concentration of main sequestrant+additive system=100 ppm). The mixtures were agitated for 1 hour at 25° C. and the final concentration of the residual H₂S was measured. The residual sulfide was quantified by electrochemical titration, using a standard 0.01 M AgNO₃ titrant solution and a modified Ag/Ag₂S electrode. Dilutions were made using distilled water as required before quantification, with the corresponding dilution factor used subsequently. All the assays were accompanied by 100 ppm of hydrogen sulfide in a blank aqueous solution of 0.01 M NaOH pH 11 with no sequestrants or additives. Expressed as a sequestration percentage, efficiency was measured through comparing residual concentrations with the concentration defined for the blank solution with no sequestrants and/or additives.

### Example 1

The sequestration capabilities of H₂S scavenger agents based on 1,3-dioxolane derivatives and/or enhancer agents were compared to the capacity of standard sequestrants to remove nitrogenated (hexahydro-3,5-tris (hydroxyethyl)-s-triazine) and non-nitrogenated (1,6-dihydroxy 2,5-dioxahexane).

### Example 2

The sequestration capabilities of three formulations were assessed, containing an H₂S scavenger agent based on 1,3-dioxolane derivatives and an ketone-based enhancer additive in a 75:25 ratio respectively.

### Example 3

The initial hydrogen sulfide sequestration rate was through sulfide removal kinetics in solution for three 1,3-dioxolane derivatives and two standard scavengers, one non-nitrogenated and one nitrogenated: (1,6 dihydroxy 2,5-dioxahexane) and (hexahydro-1,3,5-tris(hydroxyethyl)-s-triazine, respectively. Successive samples were removed for two hours, and the residual H₂O concentration was measured. Graphs were constructed for the residual concentration (ppm) x time and the initial removal rates were obtained from the resulting curves.

### Example 4

The effect of an added enhancer on the initial hydrogen sulfide sequestration rate from 1,3-dioxolane derivatives was assessed in 75:25 binary mixtures of sequestrant and additive respectively. Successive samples were removed for two hours and the residual H₂O concentration was measured. Graphs were constructed for the residual concentration (ppm) x time and the initial removal rates were obtained from the resulting curves.

TABLE 1
Hydrogen Sulfide Sequestration Efficiencies
observed for 1,3-Dioxolane Derivatives.

| | | Sequestration |
|---|---|---|
| Sequestrant Assessed | Abbrev. | Efficiency % |
| 2-methyl-1,3-dioxolane | 22MD | 88.5 |
| 2,2-dimethyl-1,3-dioxolane | 22DMD | 88.9 |
| 2-ethyl-2-methyl-1,3-dioxolane-4- | 2E2MDOL | 90.5 |
| methanol | | |
| 2-ethyl-2-methyl-1,3-dioxolane | 2E2MD | 89.5 |
| *1,6-dihydroxy-2,5-dioxahexane | DHDH | 88.8 |
| **Hexahydro-1,3,5-tris(hydroxyethyl)-s- | TAZ | 90.9 |
| triazine | | |

TABLE 2
Hydrogen Sulfide Sequestration Efficiencies
observed for ketone derivatives assessed as enhancer additives.

| Enhancer Additive | Abbrev. | Sequestration Efficiency % |
|---|---|---|
| Methyl-ethylketone | MEK | 68.3 |
| 2,3-butanedione | BDK | 82.6 |
| Cyclohexyl-cyclohexanene | CHCK | 75.8 |
| 4-hydroxy-4-methyl-pentanone | 4H4MP | 70.8 |
| 2-cyclohexanene | 2CH | 70.3 |
| Diethylketone | DEK | 59.7 |
| 2-methyl-3-hydroxy-heptenone | 3M3H5 | 73.7 |

TABLE 3
Hydrogen Sulfide Sequestration Efficiencies
observed for binary mixtures deriving from 1,3-dioxolane
derivatives and three ketones assessed.

| Main Sequestrant | Enhancer additive | % Sequestrant |
|---|---|---|
| 2E2MDOL | BDK | 88.8 |
| 2E2MD | BDK | 81.3 |
| 22DM | BDK | 82.8 |
| 2E2MDOL | CHCK | 83.5 |
| 2E2MD | CHCK | 82.9 |
| 22DM | CHCK | 87.6 |
| 2E2MDOL | 3M3H5 | 84.4 |
| 2E2MD | 3M3H5 | 84.9 |
| 22DMD | 3M3H5 | 93.2 |

TABLE 4
Comparison of Initial Sequestration Rates observed
for four pure 1,3-dioxolane derivatives and two pure nitrogenated
(**) and non-nitrogenated (*) standard sequestrants.

| | | Initial |
|---|---|---|
| | | Sequestration |
| | | Rate |
| Main Sequestrant | Abbrev. | (ppm min⁻¹) |
| 2-methyl-1,3-dioxolane | 22MD | 15.30 |
| 2,2-dimethyl-1,3-dioxolane | 22DMD | 15.06 |
| 2-ethyl-2-methyl-1,3-dioxolane-4- | 2E2MDOL | 18.80 |
| methanol | | |
| 2-ethyl-2-methyl-1,3-dioxolane | 2E2MD | 17.53 |
| *1,6-dihydroxy-2,5-dioxahexane | DHDH | 15.03 |
| **Hexahydro-1,3,5-tris(hydroxyethyl)-s- | TAZ | 17.56 |
| triazine | | |

TABLE 5
Increases in Initial Sequestration Rates observed for
binary mixtures with three 1,3-dioxolane derivatives and three
ketones assessed.

| Main | Enhancer | Initial Sequestration | Increase in initial |
|---|---|---|---|
| Sequestrant | Additive | Rate (ppm min⁻¹) | Sequestration Rate % |
| 2E2MDOL | BDK | 22.55 | 16.64 |
| 2E2MD | BDK | 22.08 | 20.61 |
| 22DMD | BDK | 22.17 | 32.10 |
| 2E2MDOL | CHCK | 22.22 | 15.40 |
| 2E2MD | CHCK | 22.18 | 20.96 |
| 22DMD | CHCK | 22.47 | 33.00 |
| 2E2MDOL | 3M3H5 | 22.30 | 15.72 |
| 2E2MD | 3M3H5 | 22.27 | 21.30 |
| 22DMD | 3M3H5 | 22.82 | 34.03 |

1. Composition of sequestrant for application to the elimination and/or reduction of hydrogen sulfide and/or mercaptans in fluid, wherein the composition comprises a mixture that comprises:
a) from 0.01% to 99.99% by weight of at least one main sequestrant of hydrogen sulfide and/or mercaptans, that will eliminate or reduce hydrogen sulfide and/or mercaptans in solution through the formation of monothioglycol, trithiepanes and/or thioacetaldehyde derivatives (Component A); and
b) from 99.99% to 0.01% by weight of at least one enhancer agent that increases the main sequestrant removal rate and that will mitigate, avoid or prevent the formation of solids and precipitates and by the subsequent generation of polysulfides through gem-thiols and/or hydroxythiols, unsaturated sulfates through enethiols and/or via dihydroxysulfides through hydroxythiols (Component B),
wherein:
Component A comprises a mixture of one or more 1,3-dioxolane derivatives represented by the structural formula below: 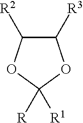
wherein:
R and R¹ independently represent —H, an alkyl chain from —CH₃ to —C₆H₁₃, a C₂-C₆ alkenyl chain, aryl, or alkylaryl, and
R² and R³ independently represent —H, —OH, an alkyl chain from —CH₃ to —C₆H₁₃, a C₂-C₆ alkenyl chain, —CH₂—OH, aryl, or alkylaryl;
Component B comprises one or more ketone-type carbonyl compounds represented by the structural formula below: 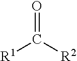
wherein:
R¹ and R² independently represent a C₁-C₈ alkyl chain, a C₂-C₈ alkenyl chain, aryl, cyclic alkenyl, hydroxy alkyl, or hydroxy alkenyl.

2. Composition according to claim 1, wherein Component A is selected from one or more of the following 1,3-dioxolane derivatives:
A1) 2-ethyl 2-methyl 1,3-dioxolane-4-ol; and/or
A2) 2-ethyl 2-methyl 1,3-dioxolane; and/or
A3) 2,2-dimethyl 1,3-dioxolane;
and Component B is selected from one or more of the following ketone derivatives:
B1) 2,3-butanedione; and/or
B2) cyclohexyl cyclohexanene; and/or
B3) 3-methyl 3-heptene-5-one.

3. Composition according to claim 2, wherein the ratio between Component A and Component B is 50:50.

4. Composition according to claim 2, wherein the ratio between Component A and Component B is 75:25.

5. Composition according to claim 1, wherein the hydrogen sulfide and/or mercaptan sequestrant product is substantially free of water.

6. Composition according to claim 1, wherein the hydrogen sulfide and/or mercaptan sequestrant product has a pH in the range of 4 to 11.

7. A method of using a sequestrant composition to reduce or eliminate hydrogen sulfide and/or mercaptans from a gas containing water and/or liquid and/or gaseous hydrocarbons, comprising the step of introducing the sequestrant composition of claim 1 to a gas containing water and/or liquid and/or gaseous hydrocarbons, wherein the sequestrant composition reduces or eliminates hydrogen sulfide and/or mercaptans from the gas containing water and/or liquid and/or gaseous hydrocarbons.

8. A method of using a sequestrant composition to reduce or eliminate hydrogen sulfide and/or mercaptans present in aqueous solutions and/or brines and/or water/oil dispersions and/or water/oil emulsions and/or oil/water emulsions, comprising the step of introducing the sequestrant composition of claim 1 to an aqueous solution and/or brines and/or water/oil dispersions and/or water/oil emulsions and/or oil/water emulsions, wherein the sequestrant composition reduces or eliminates hydrogen sulfide and/or mercaptans from the aqueous solution and/or brines and/or water/oil dispersions and/or water/oil emulsions and/or oil/water emulsions.

9. A method of using a sequestrant composition to reduce or eliminate hydrogen sulfide and/or mercaptans from a refined fuel, comprising the step of introducing the sequestrant composition of claim 1 to a refined fuel, wherein the sequestrant composition reduces or eliminates hydrogen sulfide and/or mercaptans from the refined fuel.

10. A method of using a sequestrant composition to reduce or eliminate hydrogen sulfide and/or mercaptans from a paraffin wax and/or asphaltenes and/or bitumen and/or petroleum coke, comprising the step of introducing the sequestrant composition of claim 1 to a paraffin wax and/or asphaltenes and/or bitumen and/or petroleum coke, wherein the sequestrant composition reduces or eliminates hydrogen sulfide and/or mercaptans from the paraffin wax and/or asphaltenes and/or bitumen and/or petroleum coke.

11. A method of using a sequestrant composition to reduce, eliminate or remove hydrogen sulfide and/or mercaptans from sewage gas and/or wastewater, comprising the step of introducing the sequestrant composition of claim 1 to sewage gas and/or wastewater, wherein the sequestrant composition reduces or eliminates hydrogen sulfide and/or mercaptans from the sewage gas and/or wastewater.

12. Composition according to claim 1, wherein the sequestrant product is in aqueous solution.

13. Composition according to claim 1, wherein the sequestrant product is dissolved in a hydrocarbon.

14. Composition according to claim 1, wherein the sequestrant product is dissolved in an alcohol and/or glycol and/or mixtures thereof.

15. Composition according to claim 1, wherein the sequestrant product is dissolved in a solvent.

16. Composition according to claim 1, wherein the sequestrant product is dispersed and/or emulsified in a hydrocarbon and/or water.

17. Composition of claim 1, wherein the fluid is a stream of liquid, liquid-gas or gas containing hydrogen sulfide, sulfhydryl and/or mercaptans in solution.

18. Composition of claim 3, wherein the mixture comprises:
Mixture 1: 50% A1 (2-ethyl 2-methyl 1,3-dioxolane) and 50% B3 (3-methyl 3-heptene-5-one); and/or
Mixture 2: 50% A1 (2-ethyl 2-methyl 1,3-dioxolane) and 50% B2 (cyclohexyl cyclohexanene); and/or
Mixture 3: 50% A1 (2-ethyl 2-methyl 1,3-dioxolane) and 50% B1 (2,3 butanedione); and/or
Mixture 4: 50% A2 (2-ethyl 2-methyl 1,3-dioxolane-4-ol) and 50% B3 (3-methyl 3-heptene-5-one); and/or
Mixture 5: 50% A2 (2-ethyl 2-methyl 1,3-dioxolane-4-ol) and 50% B2 (cyclohexyl cyclohexanene); and/or
Mixture 6: 50% A2 (2-ethyl 2-methyl 1,3-dioxolane-4-ol) and 50% B1 (2,3 butanedione); and/or
Mixture 7: 50% A3 (2-ethyl 2-methyl 1,3-dioxolane-4-ol) and 50% B3 (3-methyl 3-heptene-5-one); and/or
Mixture 8: 50% A3 (2-ethyl 2-methyl 1,3-dioxolane-4-ol) and 50% B2 (cyclohexyl cyclohexanene) 50%; and/or
Mixture 9: 50% A3 (2-ethyl 2-methyl 1,3-dioxolane-4-ol) and 50% B1 (2,3 butanedione).

19. Composition of claim 4, wherein the mixture comprises:
Mixture 1: 75% A1 (2-ethyl 2-methyl 1,3-dioxolane) and 25% B3 (3-methyl 3-heptene-5-one); and/or
Mixture 2: 75% A1 (2-ethyl 2-methyl 1,3-dioxolane) and 25% B2 (cyclohexyl cyclohexanene); and/or
Mixture 3: 75% A1 (2-ethyl 2-methyl 1,3-dioxolane) and 25% B1 (2,3 butanedione); and/or
Mixture 4: 75% A2 (2-ethyl 2-methyl 1,3-dioxolane-4-ol) and 25% B3 (3-methyl 3-heptene-5-one); and/or
Mixture 5: 75% A2 (2-ethyl 2-methyl 1,3-dioxolane-4-ol) and 25% B2 (cyclohexyl cyclohexanene); and/or
Mixture 6: 75% A2 (2-ethyl 2-methyl 1,3-dioxolane-4-ol) and 25% B1 (2,3 butanedione); and/or
Mixture 7: 75% A3 (2-ethyl 2-methyl 1,3-dioxolane-4-ol) and 25% B3 (3-methyl 3-heptene-5-one) 25%; and/or
Mixture 8: 75% A3 (2-ethyl 2-methyl 1,3-dioxolane-4-ol) and 25% B2 (cyclohexyl cyclohexanene) 25%; and/or
Mixture 9: 75% A3 (2-ethyl 2-methyl 1,3-dioxolane-4-ol) and 25% B1 (2,3 butanedione).

20. The method of claim 9, wherein the refined fuel is a liquefied petroleum gas and/or gasoline and/or naphtha and/or kerosene and/or other hydrocarbons.
